(19) United States
(12) Patent Application Publication
(10) Pub. No.: US 2015/0209803 A1
(43) Pub. Date: Jul. 30, 2015

(54) Centrifuge Assembly

(71) Applicant: GEA Mechanical Equipment GmbH, Oelde (DE)

(72) Inventors: Wilfried Mackel, Lippetal-Herzfeld (DE); Marie-Theres Sedler, Wadersloh (DE)

(21) Appl. No.: 14/367,674

(22) PCT Filed: Dec. 12, 2012
(86) PCT No.: PCT/EP2012/075162

§ 371 Date: Jun. 20, 2014

(30) Foreign Application Priority Data
Dec. 23, 2011 (DE) 20 2011 052 458.2

(51) Int. Cl. B04B 9/08; B04B 9/12

(52) U.S. Cl. CPC B04B 9/08; B04B 9/12

(57) ABSTRACT

A centrifuge assembly includes a centrifuge having a drum with a vertical rotational axis. The drum is placed onto a drive spindle that can be rotated by a drive and which is surrounded by a hood. The drive spindle is rotatably supported in a machine frame, which in turn can be placed on a foundation by means of at least one or a plurality of support feet. Each support foot has at least one adjustable first elastic element and at least one second elastic, preferably non-adjustable element.

### BACKGROUND AND SUMMARY OF THE INVENTION

Exemplary embodiments of the invention relate to a centrifuge assembly.

German patent document DE 10 2006 011 895 A1 disclose a generic centrifuge assembly as a separator arrangement.

According to a known embodiment, the centrifuge feet for the vibration-damped installation of the machine stand, in which the drive spindle is mounted rotatably, have in each case a circular bearing covered by a cover pot. The circular bearing has a damping action upon the vibrations of the machine in the horizontal and the vertical direction. The damping properties and the spring properties of the rubber material of the circular bearing are characteristic of this. The mass of the separator arrangements and the spring properties of the circular bearings (horizontally and vertically) result in a resonant frequency of the system, and the damping properties of the elastic material (elastomeric/rubber material) influence the degree of amplitude in the resonant frequency range.

Exemplary embodiments of the present invention are directed to a centrifuge assembly having an improved supporting foot construction.

According to the invention, it is possible to vary the spring rigidity, particularly in the horizontal direction. In this way, depending on the type of construction and the respective intended use, the centrifuge foot can be optimally tuned and set to the resonant properties of the system which are given in each case or the resonant properties of the overall system can be influenced in a simple way by the possibility of setting the centrifuge foot.

The separation into a first, adjustable elastic element for varying the spring properties and the damping properties of the second elastic element present and into a second, nonadjustable elastic element having fixed spring and damping properties is especially advantageous.

The centrifuge foot preferably has a foot carrier for introducing the forces of the supported centrifuge, in particular of the separator, into the centrifuge foot.

In this case, according to a preferred, but not mandatory variant of the invention, the adjustable first elastic element is arranged above a foot carrier and the at least one second elastic element, preferably a circular bearing or a circular bearing arrangement, is arranged below the foot carrier, the rigidity of the arrangement being adjustable by means of the upper first elastic element in terms of the characteristic resonant frequencies of installation of the rotating system, and the lower second elastic element serving for sprung installation.

In this case, additionally, the adjustment of the pressure force in the horizontal direction also has an adjusting action upon the springing in the vertical direction. In particular, the advantage is afforded that a relatively high rigidity can be set in the horizontal direction in order to shift the resonant frequencies upward.

### BRIEF DESCRIPTION OF THE DRAWING FIGURES

The invention is described in more detail below by means of an exemplary embodiment, with reference to the drawing in which:

FIG. 1 shows a diagrammatic illustration of a separator arrangement;

FIG. 2 shows a section through a first supporting foot for a separator arrangement of the type of FIG. 1;

FIG. 3 shows a section through a second supporting foot for a separator arrangement of the type of FIG. 1;

FIG. 4 shows a section through a third supporting foot for a separator arrangement of the type of FIG. 1;

FIG. 5 shows a section, perpendicular to FIG. 2 and level with the line A-A, through the supporting foot of the separator arrangement from FIG. 4; and

FIG. 6 shows a section through a third supporting foot for a separator arrangement of the type of FIG. 1.

### DETAILED DESCRIPTION

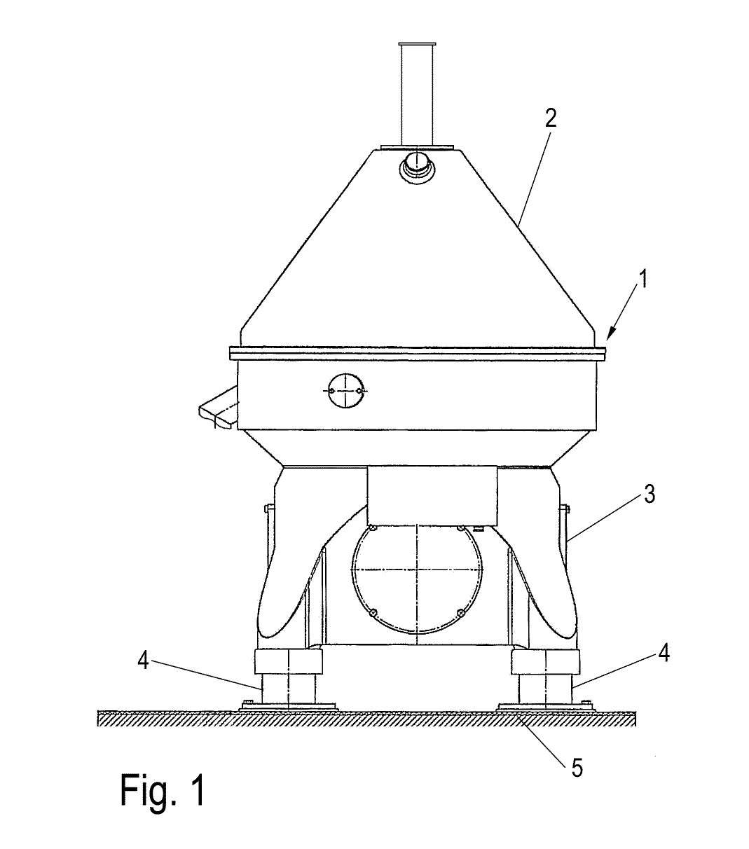

FIG. 1 shows a centrifuge assembly, here a separator arrangement, which has a centrifuge 1 with a centrifuge drum (cannot be seen here since it is covered) and with a hood 2 covering the drum.

The drum has a drive (for example, an electric motor; cannot be seen here), see in this respect, for example, one disclosed in German patent document DE 10 2006 011 895 A1). In particular, the drive is arranged in the axial extension of the rotatable drive spindle directly below the drum.

According to FIG. 1, the drive is arranged inside a machine stand 3, on which the drive spindle is mounted rotatably by means of at least one or more bearings (see in this respect, once again, the generic separator of German patent document DE 10 2006 011 895 A1).

The entire separator, that is to say the machine stand 3 with the hood 2 and with the drum together with the drive, is installed, via at least one or more supporting feet 4 which are elastic or have damping properties, on a base, such as a foundation 5, or is supported there.

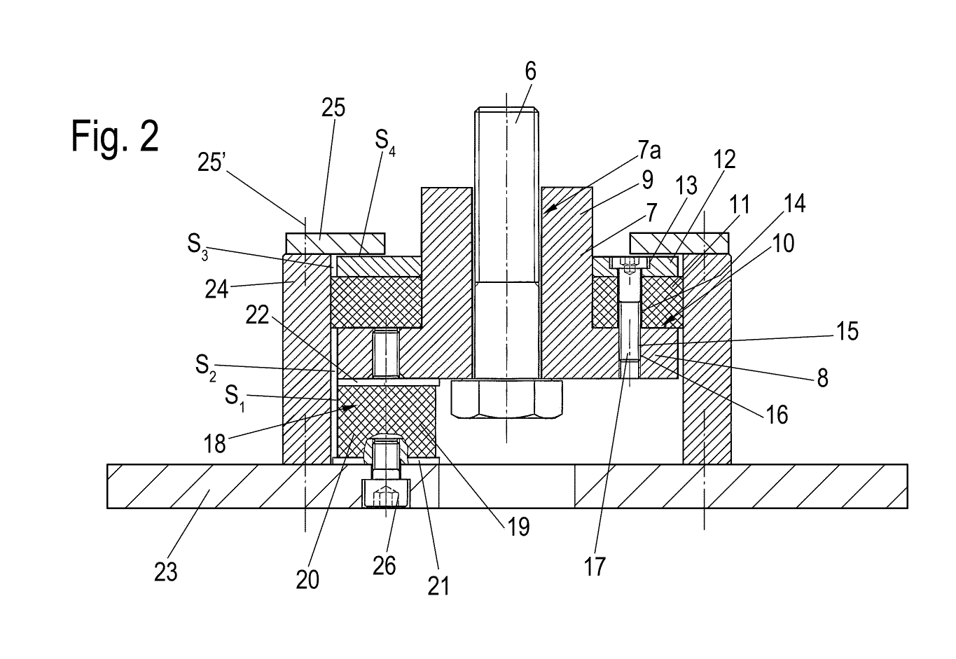

According to a first variant, the supporting feet 4 have the construction of FIG. 2 which is preferred and advantageous, but not mandatory in respect of any element illustrated.

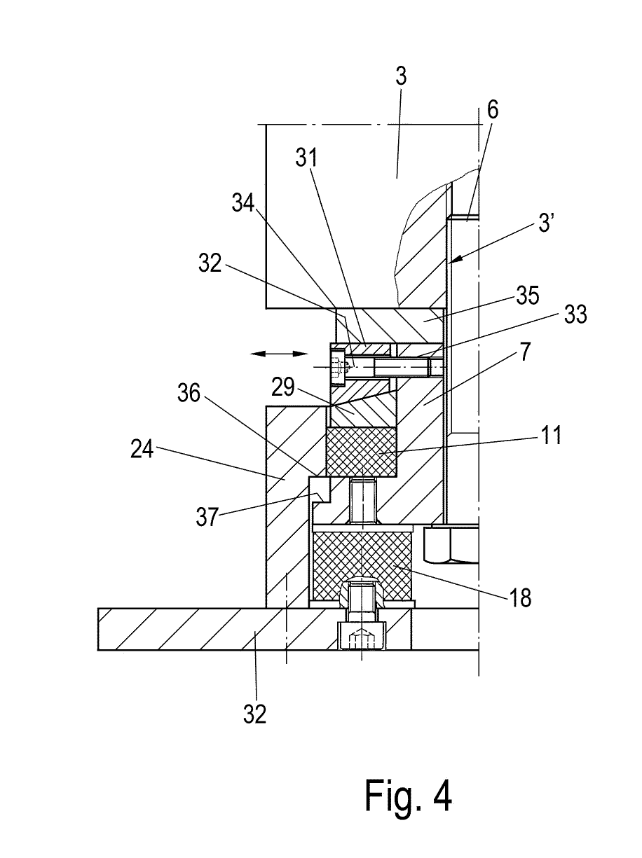

At least one screw bolt 6 (designed to be appropriately stable) serves here, per supporting foot, for fastening the supporting foot 4 to the machine stand 3 and is inserted (see in this respect for example FIG. 4) (firmly screwed) vertically from below into a corresponding threaded bore 3′ of the machine stand 3.

The term “axial” refers below to the vertical direction and the term “radial” to the horizontal direction.

According to FIGS. 2 to 4 the screw bolt 6 passes in each case vertically from below through a centric bore 7a of a stepped foot carrier which is designed here as a preferably circumferentially closed ring 7.

The ring 7 has vertically a first lower portion 8 and an upper second portion 9 having a smaller diameter than the first portion 8. In this way, a ring-shaped bearing surface 10 is formed on the ring 7 in the region in which the lower portion 8 has a larger radius than the upper portion 9. At least one first, adjustable elastic element 11 is arranged, here laid, on the bearing surface 10. A plurality of first adjustable elements 11 may also be provided. The ring 11 could thus be subdivided here into segments.

The first elastic element 11, here an elastic ring 11 in an advantageous and simple refinement, is covered, in turn, from above completely or in any event partially by a pressure means 12, preferably a ring-shaped cover disk 12.

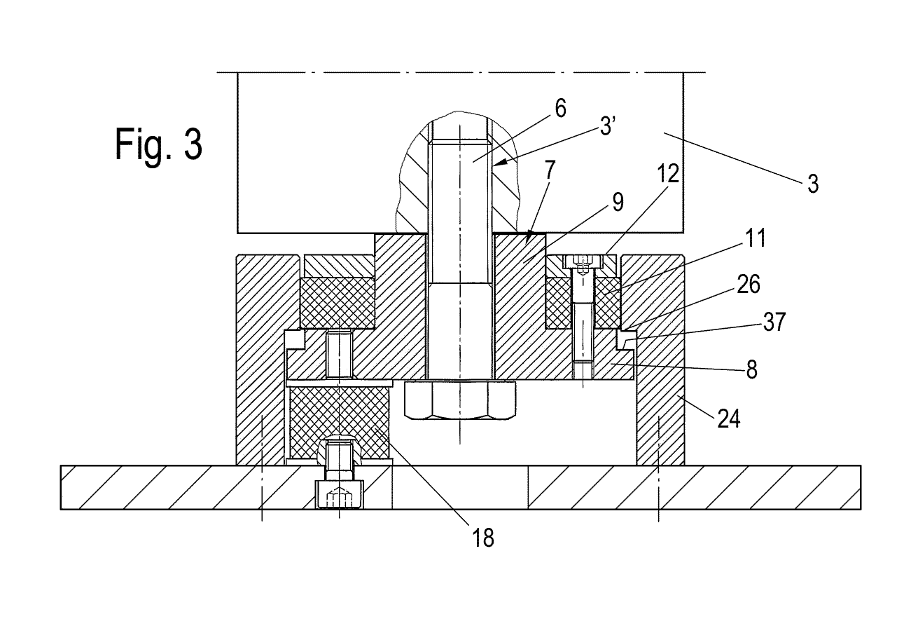

The pressure means 12, the elastic element 11 and the ring 7 have, according to FIGS. 2 and 3, vertical bores 13, 14, 15 aligned with one another in a simple way. The bores 15 in the stepped ring 7 are preferably provided with a thread 16. In this case, screw bolts 17 are inserted vertically from above into the in each case circumferentially distributed bores 13, 14, 15.

The stepped ring 7 is supported vertically downward on a circular bearing arrangement 18 having circular bearings 19, which are arranged so as to be distributed circumferentially on a circle and which have in each case an elastomer 20 between an upper and a lower plate 21, 22. The circular bearing arrangement 18 is placed, in turn, onto a lower baseplate 23.

Furthermore, an outer ring 24 is arranged/formed as an abutment for the elastic element 11 on the baseplate 23, the height of which ring corresponds here to the overall height of the circular bearing arrangement, of the inner ring 7, of the elastic element 11 and of the pressure means 12 and of a gap S4. The ring 24 is arranged on the outside concentrically to the inner ring 7, but has with respect to the latter a continuous gap S2, S3 or does not bear against this.

The outer ring 24 outwardly surrounds the circular bearing arrangement 18 and also the foot carrier 7 and the elastic element 11. The metal baseplate 23 can be pierced by screw bolts 26, which secure the circular bearings 19 and the inner ring 7 and, if appropriate, the outer ring 24 to the baseplate 23. Not all of these screw bolts are illustrated here. In the configuration according to FIG. 2, the outer ring 24 may also be integrally molded (not illustrated here) onto the baseplate.

The baseplate 23 may, in turn, be firmly screwed (not depicted here) to a base, such as a foundation, directly or via further intermediate elements.

The circular bearing or circular bearings 19 of the circular bearing arrangement 18 ensures or ensure sprung support. They constitute a design variant of the nonadjustable second elastic element.

An air gap S1, S2, S3 is preferably formed in each case between the outer ring 24 and the inner ring 7 and between the outer ring and the circular bearing or circular bearings, so that sufficient relative movement between these elements is possible during operation.

A cover element 25 fastened on the ring 24 (for example by means of screws) and projecting radially inward from the ring 24, here screwed down in the region of the line 25′, prevents the foot carrier 7 and also the pressure means 12 and elastic element 11 from creeping or being pulled apart vertically upward. The cover element here engages over the pressure means 12.

In this case, the inner ring 7, as the foot carrier, can move vertically to a limited extent as a function of the setting of the at least one elastic element 11 (gap S4 relative to the cover element, here a cover ring 25).

The supporting foot described may also be covered by a cover pot, not illustrated here, in particular as dust protection.

The at least one elastic element 11 (as a design variant of the adjustable first elastic element of claim 1) is dimensioned and arranged in such a way that it can be pressed directly onto the inner and the outer ring 7, 24 horizontally, here radially inward and radially outward with respect to the screw bolt 6, the pressure force being adjustable.

The pressure force may be set in various ways.

According to the variants of FIGS. 2 and 3, the elastic element 11 is thus compressed to a greater or lesser extent as a result of a greater or lesser tightening of the screw bolts 17, which pass through the pressure means 12 and the elastic element 11, with the result that the elastic element expands to a correspondingly greater or lesser extent radially inward and outward.

As a result, the pressure force or pressing force between the elastic element 11 and the inner or the outer abutment—foot carrier 7, outer ring 24—and consequently the spring force are varied. The inner abutment is the foot carrier, in particular the ring 7, here, and the outer abutment is the outer ring 24 which can be coupled, unsprung, to the foundation directly or via intermediate elements (plate 23).

The pressure means 12 (preferably a circumferentially closed or segmental ring) and the screw bolts 17 form in a simple way, in their interaction, a first variant of a device for varying the horizontal spring and consequently the rigidity of the centrifuge foot arrangement or centrifuge foot 4, and also its damping action.

In such setting, however, the vertical spring properties are also varied within a certain range. This is because the pressure force between the spring element 11 and the outer ring 24 is increased, and, for example, vertical springing/support also varies due to the increased friction.

According to FIG. 3, the inner ring 7 and the outer ring 24 are additionally designed in such a way that the outer ring 24 engages over the inner ring 7 with an inner annular collar 36 on an outer annular collar 37. In this region, the lower, radially larger portion 8 of the inner ring 7 on the annular collar 7 and the inner annular collar 36 of the outer ring 24 are of stepped form. The inner ring 7 is thus prevented, in an especially simple way in structural terms, from creeping or from being able to be pulled apart vertically upward from the outer ring 24. A separate cover element in the manner of the element 25 of FIG. 2 is therefore unnecessary.

The invention is not restricted to the arrangements of FIGS. 2 and 3.

Thus, instead of a single elastic element 11, a plurality of elastic elements 11, designed, for example, as circumferentially distributed ring segment portions, can also be arranged so as to be distributed circumferentially. It would then be advantageous to assign to each of these elastic elements 11 a screw or another device for varying the radial pressure force against the outer ring 24.

Moreover, the device for varying the rigidity could also be designed differently.

According to the exemplary embodiments illustrated in FIGS. 2 and 3, the radial pressure force of the elastic element 11 is varied by means of a vertically adjustable element. However, this can also be implemented in another way, thus, for example, with the aid of a wedge element arrangement composed of adjustable wedges.

Such a wedge element arrangement is preferably formed by contradirectionally arranged wedge elements 29, 31 (see FIG. 4), which lie one on the other and are adjustable horizontally in relation to one another in such a way that the vertical height of these two wedge elements 29, 31 overall, that is to say the height of the entire wedge element arrangement, is variable.

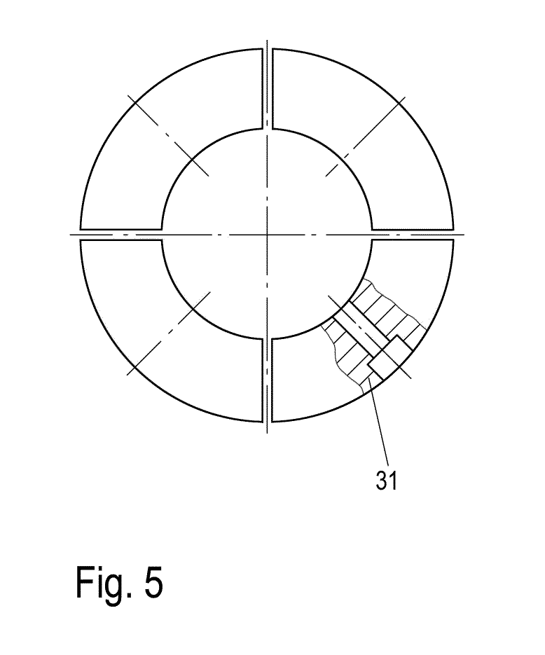

At least one or both of the wedge elements 29, 31 is or are preferably designed, as is evident from FIG. 5, as ring segments which are arranged so as to be distributed circumferentially in a ring-like manner or in a manner similar to a ring. In order to adjust the height of the wedge element arrangement, it is expedient if they and the foot carrier 7 have preferably horizontally extending bores 32, 33, which are in alignment with one another and through which in each case a screw bolt 34 passes. In this case, the bore 33 in the foot carrier 7 is preferably a threaded bore, and the screw 34 can, for example, pass through the upper wedge element 31 (the bore of which preferably has no thread) rotatably, but axially nonadjustably in relation to the wedge element.

An abutment element 35 is placed (for example screwed) here onto the foot carrier 7 and forms an upper abutment for the wedge element arrangement composed of the wedge elements 29, 30.

However, the abutment may also be formed by the foot itself. In this case, the abutment element 35 is dispensed with.

If, then, in FIG. 4 the screw bolt 34 is rotated, the upper wedge element 31 is displaced horizontally and the lower wedge element 29 is correspondingly pressed more or less vertically downward onto the elastic element 11, which is thereby compressed vertically to a greater or lesser extent and correspondingly acts horizontally with higher or lower pressure force upon the outer ring 24 and the inner foot carrier 7. The particular advantage of the arrangement from FIG. 4 is the simple horizontal adjustability, so that partial demounting of the centrifuge foot arrangement for setting operations is avoided.

FIG. 4 additionally illustrates a part of a separator stand 3, through which the screw bolt 6 passes and which is fastened in the separator foot by means of a threaded bore 3′.

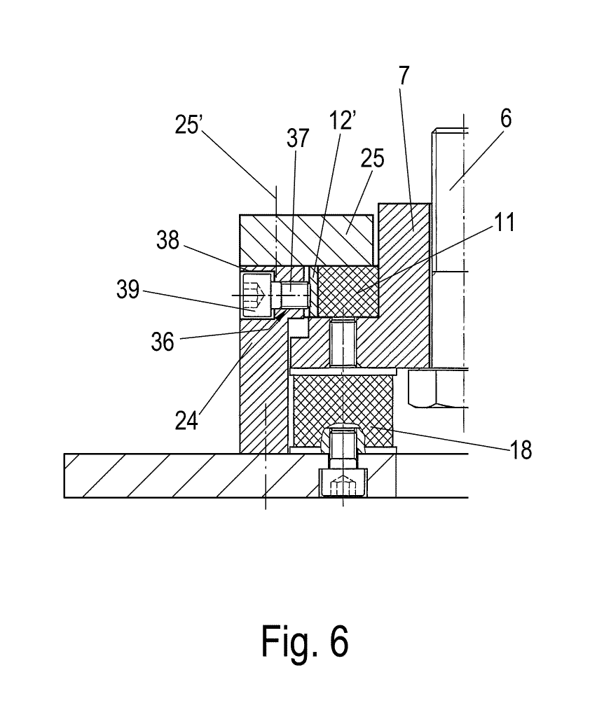

The particular advantage of simple horizontal adjustability is also afforded in the further exemplary embodiment of FIG. 6, so that, here too, partial demounting of the centrifuge foot arrangement for setting operations is avoided.

FIG. 6, which is a modification of the embodiment according to FIG. 2, provides one or more pressure means 12′, in particular circumferentially distributed pressure means, that are adjustable horizontally and act horizontally upon the at least one elastic element 11 or upon the elastic elements 11. As a result, the one elastic element 11 or the elastic elements 11 is or are compressed horizontally to a greater or lesser extent and correspondingly act horizontally with higher or lower pressure force upon the element 11 and therefore the outer ring 24, and, on the other hand, the inner foot carrier 7.

This is implemented here in that one or more circumferentially distributed screws 36 pass through threaded bores 37, level with the one elastic element 11 or the plurality of elastic elements 11, in the ring 24 and act directly or in each case via a pressure disk 12′ as pressure means within the ring 24 upon the one elastic element 11 or the plurality of elastic elements 11. The screw heads 39 may project out of the ring 24 or be arranged so as to be countersunk in portions 38 of these bores 37.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SYMBOLS

1 Centrifuge
2 Hood
3 Machine stand
3′ Bore
4 Supporting feet
5 Foundation
6 First screw bolt
7 Stepped ring
7a Bore of the ring
8, 9 Portions of the ring
10 Bearing surface
11 Elastic element
12 Pressure means
13, 14, 15 Bores
16 Thread
17 Screw bolt
18 Circular bearing arrangement
19 Circular bearing
20 Elastomer
21, 22 Plate
23 Baseplate
24 Ring
25 Cover element
25′ Line
26 Screw bolt
27 Nut
29, 31 Wedge elements
33, 33 Threaded bores
34 Screw bolt
35 Abutment element
36 Screws
37 Threaded bores
38 Portions
39 Screw head

1-25. (canceled)

26. A centrifuge assembly, comprising:
a centrifuge, which includes
a drum configured with a vertical axis of rotation,
a drive connected to a drive spindle, wherein the drive is configured to rotate the drive spindle about the vertical axis of rotation, and wherein the drum is arranged on the drive spindle,
a hood arranged to cover the drum,
a machine stand installed on a foundation by one or more supporting feet, wherein the drive spindle is mounted rotatably in the machine stand,
wherein each of the one or more supporting feet has at least one adjustable first elastic element and at least one non-adjustable second elastic element.

27. The centrifuge assembly of claim 26, wherein the at least one adjustable first elastic element is configured to set a horizontal spring rigidity and damping of the assembly and the at least one second elastic element is configured to vertically support the machine stand.

28. The centrifuge assembly of claim 26, wherein the at least one adjustable first elastic element is supported radially inward and outward on elements of the supporting foot that are movable to a limited extent in relation to one another, and a pressure force with which the at least one adjustable first elastic element is clamped between the radially inner and the radially outer element is variable as a result of compression of the elastic element.

29. The centrifuge assembly of claim 26, wherein the at least one adjustable first elastic element is arranged vertically above a non-elastic foot carrier to be damped, wherein the non-elastic foot carrier to be damped is a ring, and wherein the second elastic element is arranged below the foot carrier to be damped.

30. The centrifuge assembly of claim 26, wherein the at least one adjustable first elastic element has a ring shape.

31. The centrifuge assembly of claim 28, wherein a device for varying rigidity by varying a pressure force of the at least one adjustable first elastic element upon a) a foot carrier and b) an abutment, has a pressure means acting vertically upon the at least one first elastic element.

32. The centrifuge assembly of claim 31, wherein the pressure means acting vertically upon the elastic element can be adjusted vertically by a tool.

33. The centrifuge assembly of claim 31, wherein the pressure means acting vertically upon the elastic element can be adjusted horizontally by a tool.

34. The centrifuge assembly of claim 31, wherein the pressure means is a ring.

35. The centrifuge assembly of claim 31, wherein the pressure means is a wedge arrangement.

36. The centrifuge assembly of claim 35, wherein the wedge arrangement has wedges adjustable horizontally with respect to one another.

37. The centrifuge assembly of claim 31, wherein the pressure means acts horizontally upon the at least one elastic element or upon the elastic elements.

38. The centrifuge assembly of claim 31, wherein the abutment is provided as a radially outer ring, which surrounds the at least one adjustable first elastic element and the foot carrier.

39. The centrifuge assembly of claim 28, wherein the at least one adjustable first elastic element is a compressible elastomeric ring which is arranged between the radially inner element and the radially outer element, wherein the radially inner and outer elements are rings.

40. The centrifuge assembly of claim 39, wherein the inner ring has vertically a first lower portion and an upper second portion with a diameter smaller than that of the first portion.

41. The centrifuge assembly of claim 40, wherein a ring-shaped bearing surface is formed on the inner ring, and the at least one adjustable first elastic element is arranged on the bearing surface.

42. The centrifuge assembly of claim 41, wherein the ring-shaped bearing surface is formed on the inner ring in a region in which the lower portion has a larger radius than the upper portion.

43. The centrifuge assembly of claim 31, wherein the pressure means is a ring or ring segment, the at least one adjustable first elastic element and the ring have vertical bores aligned with one another, and screw bolts are inserted into the bores, by means of which screw bolts the elastic element can be axially deformed to a greater or lesser extent.

44. The centrifuge assembly of claim 39, wherein the inner ring is supported vertically downward on a circular bearing arrangement as a second elastic element.

45. The centrifuge assembly of claim 44, wherein the circular bearing arrangement is supported on a baseplate.

46. The centrifuge assembly of claim 45, wherein the outer ring is arranged or formed on the baseplate.

47. The centrifuge assembly of claim 45, wherein the outer ring is firmly screwed to the baseplate.

48. The centrifuge assembly of claim 44, wherein a vertical height of the outer ring corresponds to an overall height of the circular bearing arrangement, of the inner ring, of the elastic element and of the pressure means and of a gap.

49. The centrifuge assembly of claim 31, further comprising:
an abutment means arranged to prevent the foot carrier from being pulled apart vertically upward.

50. The centrifuge assembly of claim 31, wherein an annular collar is formed in each case on the inner foot carrier and on the outer ring, these annular collars, in their interaction, preventing the foot carrier from being pulled apart vertically upward.
